(19) United States
(12) Patent Application Publication
(10) Pub. No.: US 2013/0212100 A1
(43) Pub. Date: Aug. 15, 2013

(54) ESTIMATING RATE OF CHANGE OF DOCUMENTS

(71) Applicant: Google Inc., (US)

(72) Inventors: Nissan Hajaj, Emerald Hills, CA (US); Jonathon Shlens, San Francisco, CA (US); Carrie Grimes Bostock, San Francisco, CA (US); Eric Tassone, Mountain View, CA (US); Daniel Ford, East Palo Alto, CA (US)

(73) Assignee: GOOGLE INC., Mountain View, CA (US)

(21) Appl. No.: 13/726,951

(22) Filed: Dec. 26, 2012

Related U.S. Application Data
(60) Provisional application No. 61/589,856, filed on Jan. 23, 2012.

(51) Int. Cl. G06F 17/30

(52) U.S. Cl. CPC G06F 17/30011
USPC 707/736

(57) ABSTRACT

One aspect of the disclosure can be embodied in a method that includes obtaining a first document from a corpus and obtaining metadata for the first document. The method also includes obtaining existing change rates for second documents selected based on the metadata, and calculating an estimated change rate for the first document based on the change rates for the second documents.

### RELATED APPLICATIONS

This application claims priority under 35 U.S.C. §119 to Provisional Patent Application Ser. No. 61/589,856, entitled “Estimating Rate of Change of Documents” filed on Jan. 23, 2012. The subject matter of this earlier filed application is hereby incorporated by reference.

### BACKGROUND

Search engines assist users in locating information from documents, including, for example, web pages, PDFs, word processing documents, images, etc. One of the benefits of making content available over a network is ease of distributing updated content. Individual web pages—including the underlying content, media, and hyperlinks—can be created, deleted and edited constantly. While users may appreciate (and contribute to) the continuous updates, such churn presents additional information for processing. Stale or out-of-date information may degrade the search results provided by a search engine and, in the extreme case, can obviate the utility of the search engine itself

Therefore, the constant updates to web content presents a unique challenge to any web search engine, which must constantly update the search index to ensure the freshness of the index and retain the most recent version of all documents on the Internet.

### SUMMARY

One aspect of the disclosure can be embodied in a method that includes obtaining a first document from a corpus and obtaining metadata for the first document. The method also includes obtaining existing change rates for second documents selected based on the metadata, and calculating an estimated change rate for the first document based on the change rates for the second documents.

These and other aspects can include one or more of the following features. For example, calculating the estimated change rate for the first document may further comprises calculating a maximum a-posteriori estimate in addition to a prior distribution based on the existing change rates and selecting the most likely change rate. In some examples the method may also comprise scheduling a crawl of the first document based on the estimated change rate, performing a crawl of the first document according to the schedule, and adjusting the estimated change rate based on the crawl. In some implementations the metadata may include a URL associated with the first document and obtaining the existing change rates for the second documents may include identifying documents having a URL pattern similar to the URL of the document. In some examples, the method may also include measuring the distribution of the existing change rates; and fitting the distribution using method-of-moments.

Another aspect of the disclosure can be a system that includes one or more processors and a memory including instructions that, when executed by the one or more processors, cause the one or more processors to perform operations. The operations include obtaining a first document from a corpus and obtaining metadata for the first document. The operations also include obtaining existing change rates for second documents selected based on the metadata, and calculating an estimated change rate for the first document based on the change rates for the second documents.

Another aspect of the disclosure can be a tangible computer-readable storage medium having recorded and embodied thereon instructions that, when executed by one or more processors of a computer system, cause the computer system to obtain a first document from a corpus and obtain metadata for the first document. The instructions also cause the computer system to obtain existing change rates for second documents selected based on the metadata, and calculate an estimated change rate for the first document based on the change rates for the second documents.

Another aspect of the disclosure can be embodied in a method that includes obtaining a first document from a corpus and obtaining metadata for the document. The method also includes determining second documents related to the first document based on the metadata and calculating an estimated change rate for the document based on change signals for the second documents.

These and other aspects can include one or more of the following features. For example, the change signals can include a change rate associated with the second documents or the change signals can include data from a webmaster associated with the second documents. In some implementations calculating the estimated change rate for the document further comprises calculating a maximum a-posteriori estimate in addition to a prior distribution based on the change signals of the second documents and selecting the most likely change rate.

Another aspect of the disclosure can be a system that includes one or more processors and a memory including instructions that, when executed by the one or more processors, cause the one or more processors to perform operations. The operations include obtaining a first document from a corpus and obtaining metadata for the document. The operations also include determining second documents related to the first document based on the metadata and calculating an estimated change rate for the document based on change signals for the second documents.

Another aspect of the disclosure can be a tangible computer-readable storage medium having recorded and embodied thereon instructions that, when executed by one or more processors of a computer system, cause the computer system to obtain a first document from a corpus and obtain metadata for the document. The instructions also cause the computer system to determine second documents related to the first document based on the metadata and calculate an estimated change rate for the document based on change signals for the second documents.

The details of one or more implementations are set forth in the accompanying drawings and the description below. Other features will be apparent from the description and drawings, and from the claims.

### BRIEF DESCRIPTION OF DRAWINGS

FIG. 1 illustrates an example system in accordance with the disclosed subject matter.

FIG. 2 illustrates a flow diagram of an example process for estimating a change rate of a document, consistent with disclosed implementations.

FIG. 3 shows an example of a computer device that can be used to implement the described techniques.

Like reference symbols in the various drawings indicate like elements.

### DETAILED DESCRIPTION

Maintaining a fresh web index may include determining the rate at which any given web page changes, termed “the change rate.” A change rate enables prediction of when a given web page will change so that the system may schedule the web page for downloading (e.g., crawling) as close to the time of change as possible

To address such issues, systems and methods consistent with disclosed implementations present a new strategy for predicting the change rate of documents and other content available from a document corpus (e.g., the Internet). Such a predicted change rate may be used by a search engine to schedule a download (e.g., a crawl) of the new content. In some implementations, a change rate estimator module of a search engine may estimate the change rate of a document based on a calculation of the maximum a-posteriori (MAP) of the change rate based on imposing a prior distribution of the change rates of similar documents (e.g., documents from the same domain or the same document category).

In particular, the change rate estimator module may build a prior distribution of document change rates over the entire search index that is hierarchical based on the pattern of a document's metadata (e.g., its URL). The assumption behind this prior distribution is that all documents arising from the same domain, website, or directory on a website would contain increasingly similar change rates. For instance, one might expect that documents on “example.org” would change with similar rates but distinct rates than “example.gov.”

To calculate an appropriate prior distribution specific to the pattern of the URL, the change rate estimator module may measure the distribution of change rates for all URL patterns (e.g. “example.org”) and fit a prior distribution using a statistical technique termed the “method-of-moments.” Finally, to estimate the change rate of a given document (which might contain no history), the change rate estimator module may calculate the MAP estimate using the prior distribution from the most-specific pattern available for a given URL.

This estimate of change rate, termed the “pattern-specific change rate,” provides an approximation of a change rate for newly discovered documents as well as for documents with little crawl history (e.g., 1-4 crawls). This estimate in turn provides a signal for predicting when a document would be edited or updated. The scheduling system of the search engine may employ the signal to download the latest version of the document. For example, if the change rate estimator module predicts that a new document is updated weekly, the scheduling system may schedule a weekly crawl of the document. Accordingly, disclosed implementations permit the search index to maintain a reasonably up-to-date index of the documents in the corpus while minimizing the computer and network resources required.

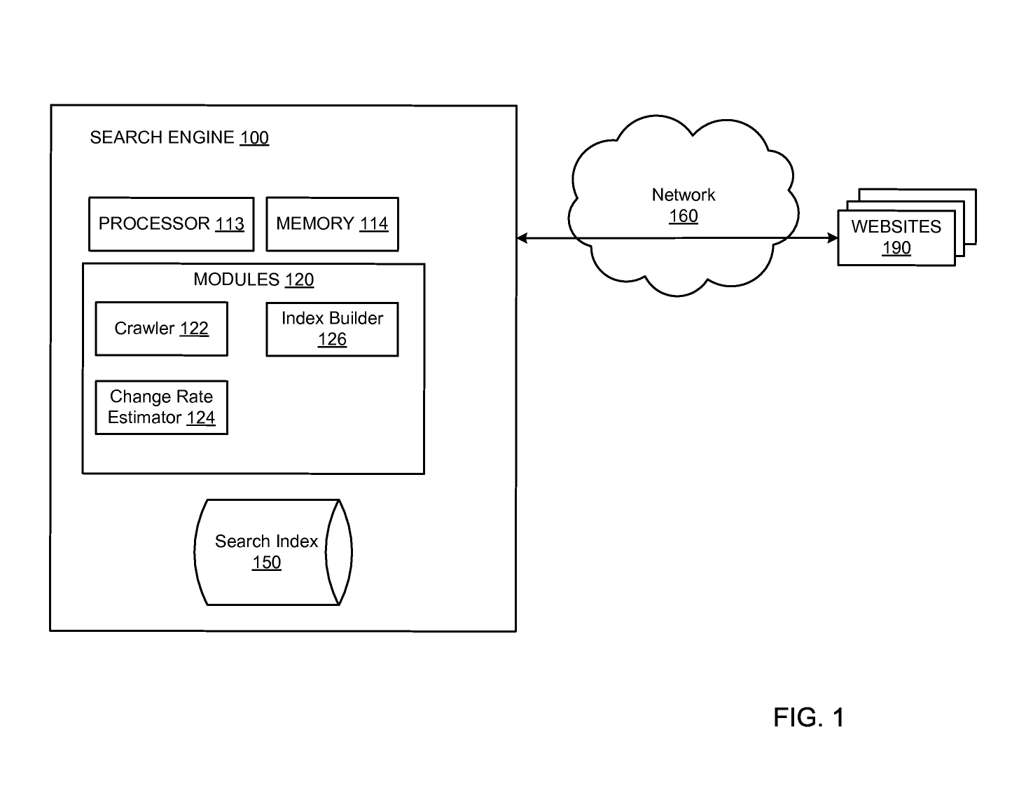

FIG. 1 is a block diagram of a search engine 100 in accordance with an example implementation. The search engine 100 may be used to implement the change estimation techniques described herein. The depiction of search engine 100 in FIG. 1 is described as an Internet-based search engine with access to documents available through the Internet. Documents may include any type of web-based content, including web pages, PDF documents, word-processing documents, images, sound files, JavaScript files, etc. But, it will be appreciated that the change estimation techniques described may be used in other configurations where the need to estimate the change rate for an item arises. For example, the search engine may be used to search local documents, or documents available through other technologies.

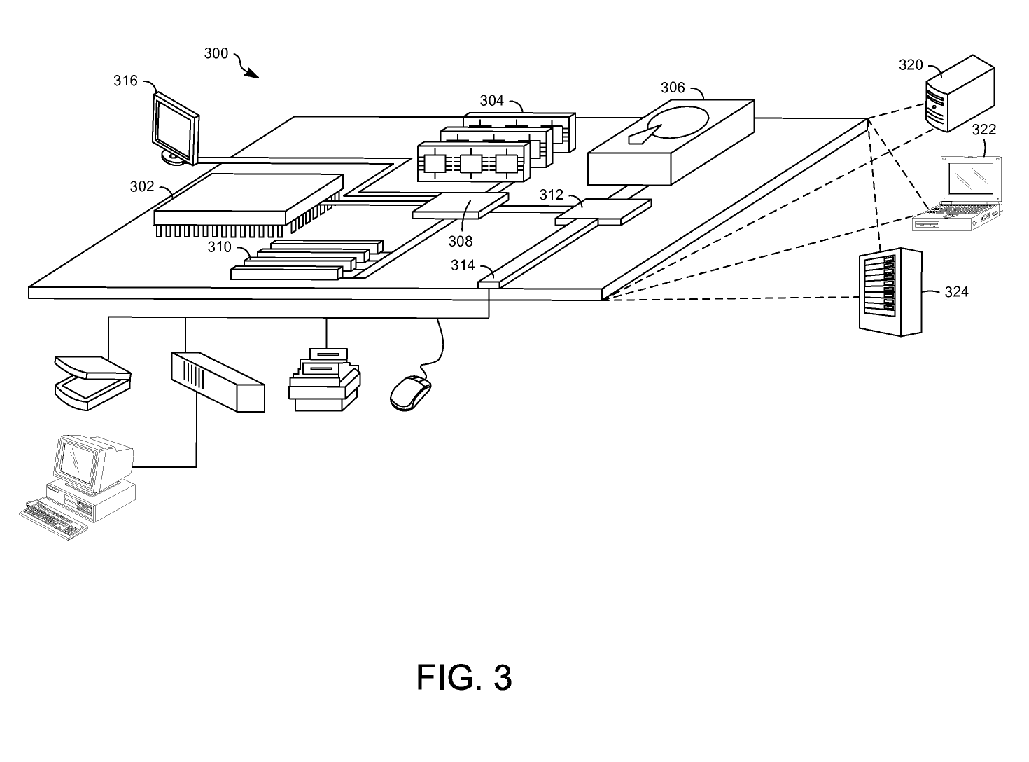

The search engine 100 may be a computing device that takes the form of a number of different devices, for example, a standard server, a group of such servers, or a rack server system. In some implementations, search engine 100 may be implemented in a personal computer, for example a laptop computer. The search engine 100 may be an example of computer device 300, as depicted in FIG. 3.

Search engine 100 can include one or more processors 113 configured to execute one or more machine executable instructions or pieces of software, firmware, or a combination thereof. The search engine 100 can include, an operating system (not shown) and one or more computer memories 114, for example a main memory, configured to store one or more pieces of data, either temporarily, permanently, semi-permanently, or a combination thereof. The memory 114 may include any type of storage device that stores information in a format that can be read and/or executed by processor 113. Memory 114 may include volatile memory, non-volatile memory, or a combination thereof. In some implementations memory 114 may store modules, for example modules 120. In some implementations modules 120 may be stored in an external storage device (not shown) and loaded into memory 114. The modules 120, when executed by processor 113, may cause processor 113 to perform certain operations.

For example, modules 120 may include a crawler module 122 that enables search engine 100 to crawl websites 190 and to retrieve documents found on the websites. Websites 190 may be any type of computing device accessible over the Internet. Crawler module 122 may include a scheduling module that schedules certain websites 190 for crawling on a periodic basis. The scheduler of crawler module 122 may use the estimated change rate to schedule a crawl of particular documents. Modules 120 may also include a change rate estimator module 124 that enables search engine 100 to calculate an estimated change rate for a newly discovered document, or a document with little crawl history. Change rate estimator module 124 may also update the estimated change rate over time to reflect the correct distribution and enable crawler 122 to more accurately schedule crawls for specific documents. Modules 120 may also include an index builder 126 that uses the documents fetched by the crawler 122 to create a search index 150. In some implementations (not shown) search index 150 may be stored in a memory device external to search engine 100. Search engine 100 may use search index 150 to respond to queries and return search results.

Search engine 100 may be in communication with the websites 190 over network 160. Network 160 may be for example, the Internet or the network 160 can be a wired or wireless local area network (LAN), wide area network (WAN), etc., implemented using, for example, gateway devices, bridges, switches, and/or so forth. Via the network 160, the search engine 100 may communicate with and transmit data from websites 190.

The search system 100 of FIG. 1 operates over a corpus of documents, for example the Internet and World Wide Web, but can likewise be used in more limited collections, for example a library of a private enterprise. In either context, documents can be distributed across many different computer systems and sites (e.g., websites 190). Regardless of where each document is located, as part of a crawl, system 100 may gather metadata about a document, including its source, its characterization, its file type, etc. This metadata may be stored as part of an entry for a document in search index 150. Search engine 100 may use such metadata to estimate a change rate for a newly discovered document.

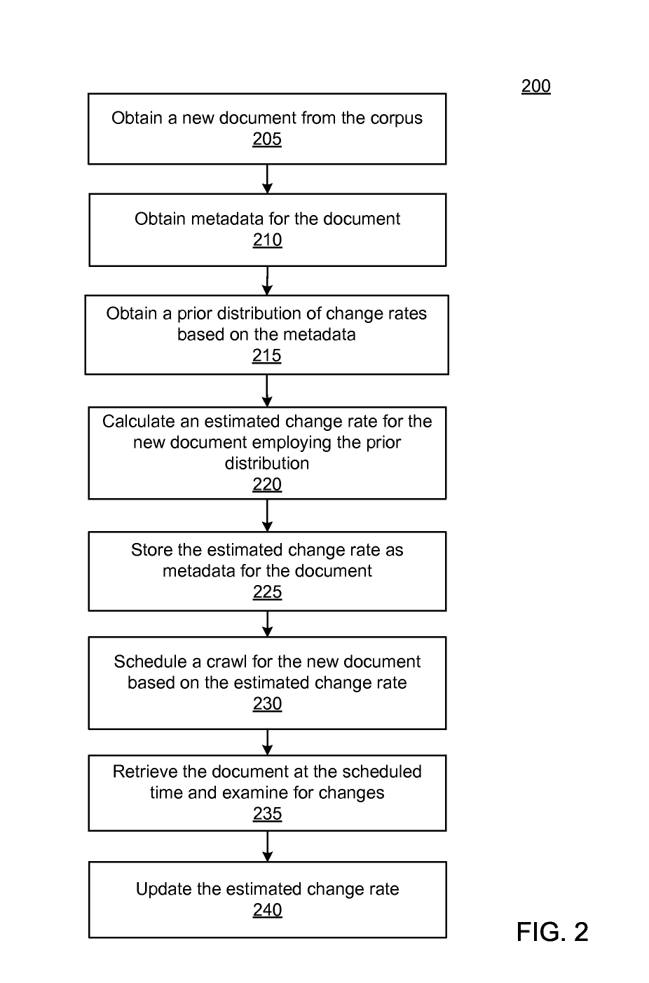

FIG. 2 is a flow diagram of an example process 200 for calculating an estimated change rate for documents. A change rate may be the rate at which the content of a page changes. In some implementations, the documents may be newly discovered or have little crawl history. Process 200 shown in FIG. 2 may be performed by a change estimator (e.g., change estimator 124 shown in FIG. 1). Process 200 may begin with the change estimator 124 obtaining a new document from the corpus (step 205). For example, as part of searching a particular domain, crawler 122 of search engine 100 may discover a web page or a PDF that was not previously on the domain and pass the web page or PDF to change estimator 124.

Change estimator 124 may then obtain metadata for the document (step 210). The metadata may include anything that is associated with the document, including data derived from the document, from the URL of the document, from the content of the document, etc. For example, change estimator 124 may derive the domain of the document (e.g., “www.example.org”) or terms used in the URL of the document (e.g., “/archive”). Alternatively or additionally, change estimator 124 may use the document type (e.g., PDF or JavaScript file) as metadata, or may use the contents of the document to determine a document category, for example a breaking news page, a blog, an auction page, or a recipe page.

Based on the metadata, change estimator 124 may obtain a prior distribution of change rates (step 215). The prior distribution may be based on the change rates for documents identified as similar based on the metadata. For example, documents from the same domain may be considered similar, as would documents with a similar term in the URL (e.g., both documents include “/archive” in the URL). In some implementations, documents of certain document types (e.g. PDF documents) may be considered similar. In some implementations, documents in the same category may be considered similar (e.g., breaking news web pages). For each similar document, the change estimator 124 may store a calculated change rate and a change-rate interval (e.g., prior parameters), so that when change estimator 124 identifies a similar document it may obtain the prior parameters for that document. The change estimator 124 may locate a plurality of similar documents based on the metadata and, accordingly, obtain a plurality of change rates and change-rate intervals as part of step 215. The plurality of change rates may be known as a set of priors. The change estimator 124 may use these calculations to calculate the prior distribution. In some implementations, the prior distribution may be given by P(λ|t,n)∝(e^{-λt})ⁿ(1−e^{-λt})ⁿ which posits that n change and n no-change crawl intervals of duration t have been observed. In such an implementation, the variable n may govern the strength of the prior by controlling how strongly it favors the mode rate

$$\frac{log 2}{t} {sec}^{- 1} .$$

For example, if the new document came from “example2.com,” the change estimator 124 may measure the distribution of change rates for all documents in index 150 from “example2.com.” The set of priors collectively represent an assumption about what can be expected for documents housed at “example2.com” (or, if the metadata is a document type, what is expected for documents sharing that document type, etc.). As indicated above, in some implementations, the parameters of the prior distribution specific to the URL pattern may be pre-calculated and stored as metadata associated with the document. Documents having more metadata in common (e.g., the more similar the URL, or a document having the same type from the some domain) are more likely to predict the actual change rate of the new document. Thus, in some implementations, the change rates associated with these candidate prior documents may be included over (or weighted over) the change rates of documents with less similarities based on the metadata. The change estimator 124 may fit a prior distribution of the change rates using a common statistical technique known as the method of moments. The method of moments may be used to determine the shape (pattern) of the underlying distribution by comparing four moments (e.g., the mean, variance, skewness, and kurtosis) of the distribution with a theoretical distribution.

As mentioned above, in some implementations, change estimator 124 may limit the candidate priors from the prior distribution. For example, change estimator 124 may use the expected period between changes (t) and the strength of the belief (n) represented by the number of intervals (crawls) to limit the strength of the priors. Such limits may enable the change rate estimator module of change estimator 124 to limit the prior strengths so that the change rate estimator module does not have too much data to converge to the correct change rate for a given URL (for example).

In some implementations, other change signals besides a document's change history may be used in the change prediction model. For example, in some implementations, change estimator 124 may use signals from webmasters. For instance, change estimator 124 may have access to a log or other feed from a webmaster of the domain that gives an indication about a document's change history or predicted changes. In some implementations, a signal from a webmaster or from the content of the document may indicate that the document is part of an archive, meaning that the document will not change often. In some implementations, change estimator 124 may deduce that many of the documents hosted on a particular domain are not available (e.g., return a “404, page not found” error). This may be an indication that other pages on the domain are also not available. Thus, change estimator 124 may use various signals to model the change probability.

Change estimator 124 may then calculate an estimated change rate for the new document based on the prior distribution (step 220). For example, the change estimator 124 may calculate a maximum a posteriori (MAP) estimate using a Poisson process likelihood in addition to the prior distribution to determine the most likely change rate estimate. Change estimator 124 may choose the change rate with the most likely probability as the estimated change rate for the new document. Change estimator 124 may store the calculated change rate as metadata for the new document in the search index 150 (step 225) and schedule a crawl of the new document based on the calculated change rate (step 230). For example, if the calculated change rate is 3 days, the change estimator 124, or another component of search engine 100, may schedule another crawl of the document in 3 days time.

When the time for the next scheduled crawl of the document arrives, the change estimator 124, or the crawler 122, may retrieve the document from the Internet and determine whether the document has changed since the last download (step 235). Change estimator 124 may store an indication of whether the document has changed as metadata associated with the document in the crawl history (e.g., in index 150). This record of changes may help change estimator 124 determine what the actual change rate is for the document and, when the history becomes extensive enough (e.g., after six or more crawls), help change estimator 124 estimate the change rate for other documents.

Change estimator 124 may also adjust the estimated change rate (step 240). For example, change estimator 124 may recalculate the maximum a posteriori estimate of the change rate using the Poisson likelihood based on the metadata and the associated prior distribution (e.g., using steps 210 through 220). Change estimator 124 may repeat steps 225 to 240 iteratively, allowing change estimator 124 to gradually adjust the estimated change rate over time so that it better approximates the actual change rate of the document. Because the change rate is stored as document metadata, the change rate may be used to calculate an estimate on other documents sharing similar metadata. Though such adjustments, change estimator 124 may reduce the processing resources needed to create and maintain a fresh search index 150.

FIG. 3 shows an example of a generic computer device 300 which may be used with the techniques described here. Computing device 300 is intended to represent various forms of digital computers, e.g., laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, for example, display 316 coupled to high speed interface 308. In some implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a volatile memory unit or units. In another implementation, the memory 304 is a non-volatile memory unit or units. The memory 304 may also be another form of computer-readable medium, for example, a magnetic or optical disk.

The storage device 306 is capable of providing mass storage for the computing device 300. In one implementation, the storage device 306 may be or contain a computer-readable medium, for example, a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, for example, the memory 304, the storage device 306, or memory on processor 302.

The high speed controller 308 manages bandwidth-intensive operations for the computing device 300, while the low speed controller 312 manages lower bandwidth-intensive operations. Such allocation of functions is exemplary only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, for example, a keyboard, a pointing device, a scanner, or a networking device, for example a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer like laptop computer 322. Alternatively, components from computing device 300 may be combined with other components in a mobile device (not shown). An entire system may be made up of multiple computing devices 300 communicating with each other.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
obtaining a first document from a corpus;
obtaining metadata for the first document;
obtaining existing change rates for second documents selected based on the metadata; and
calculating an estimated change rate for the first document based on the change rates for the second documents.

2. The method of claim 1, wherein calculating the estimated change rate for the first document further comprises:
calculating a maximum a-posteriori estimate in addition to a prior distribution based on the existing change rates; and
selecting the most likely change rate.

3. The method of claim 1, further comprising scheduling a crawl of the first document based on the estimated change rate.

4. The method of claim 3, further comprising:
performing the crawl of the first document according to the schedule; and
adjusting the estimated change rate based on the crawl.

5. The method of claim 1, wherein the metadata includes a URL associated with the first document.

6. The method of claim 5, wherein obtaining the existing change rates for the second documents includes:
identifying documents having a URL pattern similar to the URL of the document.

7. The method of claim 6, further comprising:
measuring a distribution of the existing change rates; and
fitting the distribution using method-of-moments.

8. A tangible computer-readable storage medium having recorded and embodied thereon instructions that, when executed by one or more processors of a computer system, cause the computer system to perform the method of claim 1.

9. A computer-implemented method comprising:
obtaining a first document from a corpus;
obtaining metadata for the document;
determining second documents related to the first document based on the metadata; and
calculating an estimated change rate for the document based on change signals for the second documents.

10. The method of claim 9, wherein the change signals include a change rate associated with the second documents.

11. The method of claim 9, wherein the change signals include data from a webmaster associated with the second documents.

12. The method of claim 9, wherein calculating the estimated change rate for the document further comprises:
calculating a maximum a-posteriori estimate in addition to a prior distribution based on the change signals of the second documents; and
selecting the most likely change rate.

13. A tangible computer-readable storage medium having recorded and embodied thereon instructions that, when executed by one or more processors of a computer system, cause the computer system to perform the method of claim 9.

14. A system comprising:
one or more processors; and
a memory storing instructions that, when executed by the one or more processors, cause the one or more processors to perform operations comprising:
obtaining a first document from a corpus,
obtaining metadata for the first document,
obtaining existing change rates for second documents selected based on the metadata, and
calculating an estimated change rate for the first document based on the change rates for the second documents.

15. The system of claim 14, wherein the operation of calculating the estimated change rate for the first document further comprises:
calculating a maximum a-posteriori estimate in addition to a prior distribution based on the existing change rates; and
selecting the most likely change rate.

16. The system of claim 14, further comprising instructions that cause the one or more processors to perform the operation of scheduling a crawl of the first document based on the estimated change rate.

17. The system of claim 16, further comprising instructions that cause the one or more processors to perform the operations of:
performing the crawl of the first document according to the schedule; and
adjusting the estimated change rate based on the crawl.

18. The system of claim 14, wherein the metadata includes a URL associated with the first document.

19. The system of claim 18, wherein the operation of obtaining the existing change rates for the second documents includes:
identifying documents having a URL pattern similar to the URL of the document.

20. The system of claim 19, further comprising instructions that cause the one or more processors to perform the operations of:
measuring a distribution of the existing change rates; and
fitting the distribution using method-of-moments.
